(19) United States
(12) Patent Application Publication
(10) Pub. No.: US 2007/0081290 A1
(43) Pub. Date: Apr. 12, 2007

(54) Ionizer incorporated with electronic appliance

(75) Inventors: Shu-Hua Lai, Sindian City (TW); Hui-Chen Wang, Puyan Township (TW); Wei-Huan Chou, Yonghe City (TW); Chien-Chuan Chen, Taipei (TW); Chi-Fen Chang, Shulin City (TW); Han-Shun Wu, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Corporation, Taipei (TW)

(21) Appl. No.: 11/248,528

(22) Filed: Oct. 12, 2005

(51) Int. Cl. H01H 47/00

(52) U.S. Cl. 361/220

(57) ABSTRACT

An ionizer incorporated with an electronic appliance utilizes the power supply of the appliance so that only less device and space are required for the additional ion function. The small power-consumption ionizer does not influence the original function of the electronic device while the negative ions help refreshing the air and improving people's moods, energy and health.

### BACKGROUND OF THE INVENTION

1. Field of the Invention

The invention generally relates to an ionizer incorporated with an electronic appliance, and in particular relates to an ionizer incorporated with an electronic appliance by utilizing the power supply of the appliance.

2. Description of the Prior Art

Televisions, computers, microwave ovens and many electrical and electronic appliances generate electromagnetic waves and plenty of positive ions. People in such an environment are easy to get tired since the positive ions may harm our bodies and moods. Some studies showed that places with a lot of positive ions such as polluted environments can supposedly reduce our immune ability, affect blood circulation, and accelerate aging. In contrast, forests, mountains, rivers and waterfalls that contain a lot of negative ions, are relaxing and can reverse the effects of serotonin. They cancel out the ill effects of positive ions and promote good health. Researchers believe that through control of the electrical charges in the air we breathe, our moods, energy and health can be markedly improved. Negative ions are exceedingly beneficial for a person's metabolism as a means of enhancing human behavior. They act in a complex mechanism to bring about hormone and biochemical reactions in the body and brain.

From a health point of view, negative ions have the advantages of blood purification, cell activation, enhancement of the immune system, and adjustment of autonomic nerve.

Also, negative ions help remove dust, pollen, mold spores, and other allergens from the air, because negative ions cause dust, pollen, mold spores, pet dander, etc. to clump together and drop out of the air.

The negative ion generators or ionizers mainly apply discharge methods, such as corona discharge and silent discharge (also named dielectric barrier discharge).

Corona discharge utilizes a high curvature electrode, such as a needle or an ultra thin wire. The high curvature electrode produces an ultra-high potential gradient so as to discharge easily. The discharged ions can be positive or negative depending on the polarity of the electrode. A positive electrode discharges positive ions. A negative electrode discharges negative ions.

### SUMMARY OF THE INVENTION

In view of electronic appliances that generate electromagnetic wave and positive ions do harms to human mental and physical health; while negative ions help defending the bad influence of positive ions, helping people health, and removing dust and allergens, the invention provides an ionizer incorporated with an electronic appliance. Since people usually use electronic appliances for a long period of time and in close touching, the invention directly helps people's heath in an easy way.

The object of the invention is to provide an ionizer incorporated with an electronic appliance. The ionizer is powered by a high voltage generator extending from original power supply. The ionizer takes small wattage that does not influence the operation of the appliance.

Another object of the invention is to provide an ionizer incorporated with an electronic appliance. The ionizer is powered by a high voltage generator extending from original power supply. The negative ions are generated by corona discharge.

An ionizer incorporated with an electronic appliance according to the invention includes an electronic appliance having a power supply; a high voltage generator, connected with the power supply, for outputting a negative voltage; a metallic needle, connecting with the negative voltage and having a tip for discharge; an insulative tube, protecting the metallic needle and having an air inlet and an air outlet; and a metallic mesh covering the air outlet for absorbing electrical charges and preventing user from electrical shock. The air entering into the insulative tube via the air inlet becomes negative ions when being adhered by the electrons discharged from the metallic needle, and comes out from the air outlet. The air inlet can further be connected to an outlet of a heatsink fan of the electronic appliance so that the fan-forced air is blown through the insulative tube, discharged into negative ions and comes out from the air outlet.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1A is an exemplary view of a corona discharge ionizer incorporated with an electronic appliance according to the invention;

FIG. 1B is a sectional view of a corona discharge ionizer of the invention incorporated with an electronic appliance; and

FIG. 1C is a perspective view of a corona discharge ionizer of the invention incorporated with an electronic appliance.

### DETAILED DESCRIPTION OF THE INVENTION

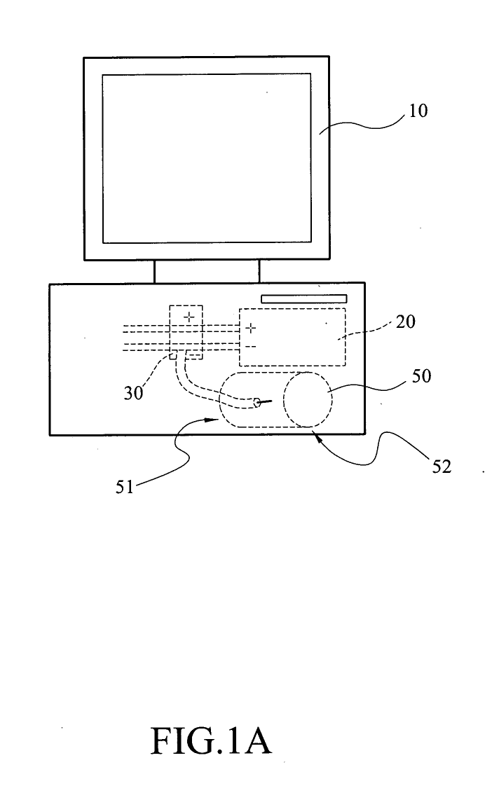

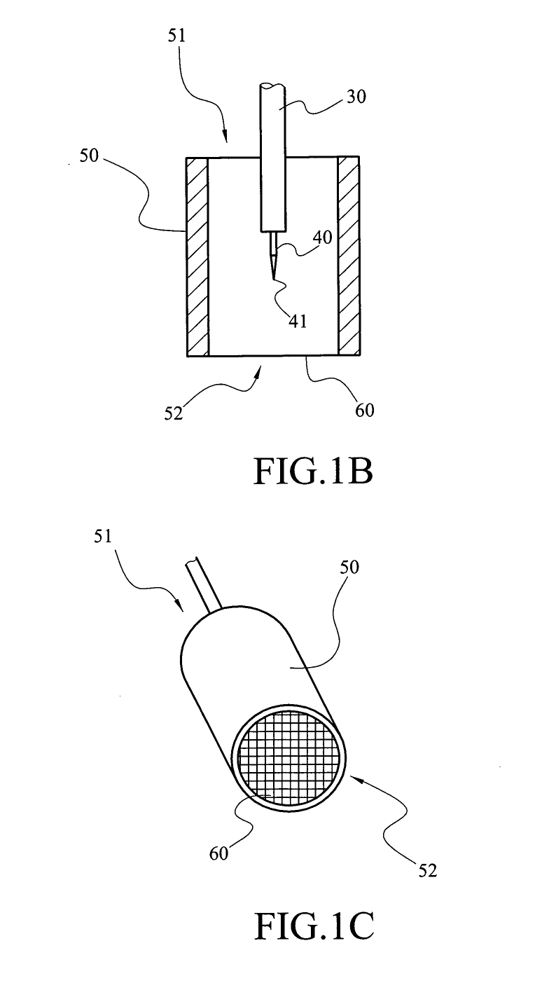

Referring to FIG. 1A to FIG. 1C, a preferred embodiment of the invention, in which FIG. 1A is an exemplary view of application; FIG. 1B is a sectional view of the corona discharge ionizer and FIG. 1C is a perspective view of the ionizer. An electronic appliance 10 includes a power supply 20. A high voltage generator 30 is connected with the power supply 20 for outputting a negative voltage. A metallic needle 40 is connected with the high voltage generator 30 and formed with a tip 41 for discharge. The metallic needle 40 is made of copper, iron, stainless steel, tungsten or suitable alloys. The tip 41 has a tiny curvature radius so as to produce an ultra-high potential gradient and discharge easily when being provided with the high electrical voltage. An insulative tube 50 protects the metallic needle 40 and formed with an air inlet 51 and an air outlet 52. The insulative tube 50 is made of plastics. The shape of the insulative tube 50 is not limited to a cylindrical tube as shown, but other shapes, like square or polygons, can also be used. The air entering into the insulative tube 50 via the air inlet 51 becomes negative ions when being adhered by the electrons discharged from the tip 41 of metallic needle 40, and comes out from the air outlet 52. A higher voltage applied on the metallic needle 40 outputs more negative ions. The air inlet 51 can also be connected to an outlet of a heatsink fan (not shown) of the electronic appliance 10 so that the fan-forced air is blown from the air inlet to the insulative tube 50, discharged into negative ions by the tip 41 and comes out from the air outlet 52. As shown in FIG. 1C, a metallic mesh 60 covers the air outlet 52 to absorb electrical charges and prevents user from electrical shock. The metallic mesh 60 is made of copper, iron, stainless steel, aluminum or suitable alloys. In FIG. 1A, the electronic appliance 10 is a desktop computer. However, in application, the electronic appliance 10 can be a notebook computer, multimedia device, liquid crystal display television, modem or the like. For example, when being applied to a speaker cabinet, the air outlet 52 of the ionizer is placed in front of a speaker so that negative ions are facilitated to disperse by the vibration of the speaker.

In conclusion, an ionizer incorporated with an electronic appliance according to the invention utilizes the power supply of the appliance so that only less device and space are required for the additional ion function. The small power-consumption ionizer does not influence the original function of the electronic device while the negative ions help refreshing the air and improving people's moods, energy and health.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An ionizer incorporated with an electronic appliance to utilize a power supply of the appliance, comprising:
a power supply;
a high voltage generator, connected with the power supply, for outputting a negative voltage;
a metallic needle, connecting with the negative voltage and having a tip for discharge; and
an insulative tube, protecting the metallic needle and having an air inlet and an air outlet; Therefore, air entering into the insulative tube via the air inlet becoming negative ions when being adhered by electrons discharged from the tip of metallic needle, and coming out from the air outlet.

2. Then ionizer incorporated with an electronic appliance according to claim 1 wherein the metallic needle is selected from the group consisting of copper, iron, stainless steel, tungsten and their alloys.

3. The ionizer incorporated with an electronic appliance according to claim 1 wherein the insulative tube is made of plastics.

4. The ionizer incorporated with an electronic appliance according to claim 1 wherein the insulative tube having a shape chosen from circle, square and polygons.

5. The ionizer incorporated with an electronic appliance according to claim 1 wherein a higher voltage provided by the high voltage generator enhances the negative ions output.

6. The ionizer incorporated with an electronic appliance according to claim 1 wherein the air outlet of the ionizer is connected to an outlet of a heatsink fan of the electronic appliance.

7. The ionizer incorporated with an electronic appliance according to claim 1 wherein the electronic appliance is one chosen from a group at least comprising desktop computer, notebook computer, multimedia device, liquid crystal display television and modem.

8. The ionizer incorporated with an electronic appliance according to claim 7 wherein the air outlet of ionizer is placed in front of a speaker of the multimedia device so that negative ions are facilitated to disperse by vibration of the speaker.

9. The ionizer incorporated with an electronic appliance according to claim 1 further comprises a metallic mesh covering the air outlet to absorb electrical charges and to prevent user from electrical shock.

10. The ionizer incorporated with an electronic appliance according to claim 9 wherein the metallic mesh is selected from the group consisting of copper, iron, stainless steel, aluminum and their alloys.
